(19) United States
(12) Patent Application Publication
(10) Pub. No.: US 2009/0313017 A1
(43) Pub. Date: Dec. 17, 2009

(54) Language model update device, language Model update method, and language model update program

(76) Inventors: Satoshi Nakazawa, Tokyo (JP); Hitoshi Yamamoto, Tokyo (JP); Tasuku Kitade, Tokyo (JP)

Correspondence Address: FOLEY AND LARDNER LLP;SUITE 500, 3000 K STREET NW, WASHINGTON, DC, 20007, US

(21) Appl. No.: 12/309,044

(22) PCT Filed: Jul. 6, 2007
(86) PCT No.: PCT/JP2007/063577

§ 371 Date: Jan. 5, 2009

(30) Foreign Application Priority Data
Jul. 7, 2006 (JP) 2006-187952

(51) Int. Cl. G10L 15/06

(52) U.S. Cl. 704/244; 704/E15.001

(57) ABSTRACT

A framework in which a numerical value that represents a statistical appearance tendency of each of words in a language model is set with respect to the words not only as a constant, but also as an update function that changes in time, is included. The numerical value that represents the set statistical appearance tendency of a word is automatically updated in accordance with passage of time. A time information inputting section 50 that receives elapsed time from a time point set in advance or date and time information, an update target and update function storage section 20 that retains a pair of a word to be updated or a condition of words to be updated and an update function, and a language model update section 40 that updates a language model of the word to be updated or a group of words that satisfy the condition of words to be updated based on the update function that is paired up with each of the update targets in accordance with the elapsed time received by a time information inputting means, are included.

### TECHNICAL FIELD

The present application is based on Japanese Patent Application No. 2006-187952 (filed on Jul. 7, 2006), and claims the benefit of priority under the Paris Convention from Japanese Patent Application No. 2006-187952. A content of disclosure of Japanese Patent Application No. 2006-187952 is incorporated herein by referencing Japanese Patent Application No. 2006-187952.

The present invention relates to a language model update device and method, and a processing program thereof. In particular, the present invention relates to a language model update device and method, and a processing program thereof, in which, when a new word and an unknown word are newly added to a language model, and when statistical information of existing words in the language model is modified, the language model is set to be changed by a function determined in advance according to elapsed time, instead of a value that is constant and unchanged, and statistical information of each word is updated in accordance with the setting automatically thereafter.

### BACKGROUND ART

In a voice recognition technique and a character recognition technique, a language model that models a statistical appearance tendency and restriction of words to be recognized is widely used in order to improve recognition performance. Non-Patent Document 1 describes a creation method of such a language model and a representative case thereof.

Once a language model is created from a text corpus that is a basis for creation of the language model, a numerical value that represents a statistical appearance tendency of words in the model is unchanged, except for processing of addition and deletion of the words. Therefore, when a statistical appearance tendency of a word included in input to a voice recognition device or a character recognition device is changed due to a change in time and in an environment, the language model needs to be created again.

In addition, when a word, such as a new word and an unknown word, is newly added to a recognition dictionary, restriction and a statistical appearance tendency of the word to be added needs to be added to the language model. In a voice recognition technique, when a word is newly added, there is widely used a method of adding a certain value set in advance to a language model as a statistical appearance tendency of the word to be added in accordance with a part of speech and a class of the word.

Further, in Patent Document 1, there is disclosed a technique, in which an unknown word section in input text and a class thereof are assumed by pattern matching processing after the input text is morphologically analyzed, and an appearance probability of the unknown word is calculated based on the assumed class, thereby obtaining a language model.

### Patent Document 1: JP-A-2006-59105

### Patent Document 2: JP-A-2002-229589

Non-Patent Document 1: Kita, Kenji, “Probabilistic Language Model”, University of Tokyo Press, 1st edition on Nov. 25, 1999, Chapter 2

### DISCLOSURE OF THE INVENTION

### Problems to be Solved by the Invention

In a language model related to the present invention, once a language model is created, a numerical value that represents a statistical appearance tendency of a word in the model is unchanged. The method disclosed in Patent Document 1 is also for estimating an appropriate value for a numerical value that represents a statistical appearance tendency of a word, such as a new word and an unknown word, at a certain time point when the word is added to a recognition dictionary. Accordingly, there is no difference with respect to the point that a constant value is taken after creation of a language model.

Therefore, as described in the description of the background art, when a statistical appearance tendency of a word included in input to a voice recognition device or a character recognition device is changed due to change in time and in an environment, there is a problem that the language model needs to be created again in accordance with the change. If a language model is periodically created again from zero, a language model that is optimum at this time point is obtained, and recognition processing using the language model has improved performance. However, in the above method, every time a language model is created again, a text corpus as a reference for creation of the language model needs to be prepared in a sufficient amount for estimating a statistical appearance tendency of each word, and a large cost is required. In addition, when a voice recognition device is embedded in a household appliance, and used in the household appliance alone, a language model used in the voice recognition device cannot be created again easily.

The present invention has been made in order to solve the above problem. A first exemplary object of the present invention is to provide a language model update device, a language model update method, and a language model update program that include a framework, in which a numerical value representing a statistical appearance tendency is set not only as a constant, but also as a update function that changes temporally, with respect to a word in a language model, where a numerical value representing a statistical appearance tendency of a word set in accordance is automatically updated according to passage of time.

### Means for Solving the Problems

According to a first exemplary aspect of the present invention, there is provided a language model update device, characterized by including a time information inputting means for receiving elapsed time from a time point set in advance or date and time information, an update target and update function storing means for retaining a pair of a word to be updated or a condition of words to be updated and an update function, and a language model updating means for updating a language model of the word to be updated or a group of words that satisfy the condition of words to be updated based on the update function that is paired up with each of the update targets in accordance with the elapsed time received by the time information inputting means.

### ADVANTAGES OF THE INVENTION

An advantageous effect of the present invention is that a language model of words, for which a change pattern of a statistic appearance tendency in future can be predicted, can be automatically updated.

A reason why the above advantageous effect can be obtained is that the present invention includes a means for retaining a pair of a word or a group of words, for which a future change pattern of a statistical appearance tendency can be predicted, and a predicted change pattern thereof, as a pair of a word to be updated or a condition for words to be updated and an update function thereof, separately from a normal language model. A language model of a word to be updated among words in the language model is updated along passage of time in accordance with the retained update function.

Although predicting a future change pattern of a statistical appearance tendency of a general word is difficult, a change pattern of a current word, a seasonal word, and the like can be predicted to some extent. Therefore, such words are retained with predicted change patterns in pairs, and a language model is automatically updated in accordance with such pairs. In this manner, in a recognition device using the language model, a situation where a current word is output in error even after the current word is out of date can be prevented.

In addition, another advantageous effect of the present invention is that, even when there is an error in a predicted change pattern of a statistical appearance tendency of a word, a language model of the word to be updated can be automatically updated with the error being reduced.

A reason why the above advantageous effect can be obtained is that a language model that is automatically updated is evaluated, and when the evaluation is low, an update function of a word to be updated is modified so as to obtain high evaluation.

Even for a word, such as a current word used in news, which can be predicted to be out of date after a certain period of time but cannot be predicted to be out of date precisely to what extent, a language model of the word is updated in accordance with a final appearance frequency.

### BRIEF DESCRIPTION OF THE DRAWINGS

FIG. 1 is a block diagram showing a configuration of a first exemplary embodiment of the present invention;

FIG. 2 is a change pattern example 1 set as an update function;

FIG. 3 is a change pattern example 2 set as an update function;

FIG. 4 is a change pattern example 3 set as an update function;

FIG. 5 is a change pattern example 4 set as an update function;

FIG. 6 is a change pattern example 5 set as an update function;

FIG. 7 is a flowchart showing operation of the first embodiment of the present invention;

FIG. 8 is a block diagram showing a configuration of a second embodiment of the present invention;

FIG. 9 is a block diagram showing a detailed configuration of a language model evaluation device of when a voice recognition processing is used;

FIG. 10 is a block diagram showing a detailed configuration of the language model evaluation device of when a sample text corpus with time information is used; and

FIG. 11 is a flowchart showing update target and update function modification operation in the second exemplary embodiment of the present invention.

### EXPLANATION OF REFERENCE SYMBOLS

10: Update word input section
20: Update target and update function storage section
30: Language model
40: Language model update section
50: Time information input section
60: Language model evaluation device
70: Update target and update function modification section
610: Language model history storage section
620: Voice recognition engine
630: Acoustic model
640: Input voice buffer
650: Recognition evaluation section
660: Evaluation result determination section
670: Time information attached sample text corpus
680: Statistical information comparison section
690: Statistical comparison result determination section

### BEST MODE FOR CARRYING OUT THE INVENTION

Hereinafter, a detailed description will be made with respect to exemplary preferred embodiments for implementing the present invention with reference to the accompanying drawings.

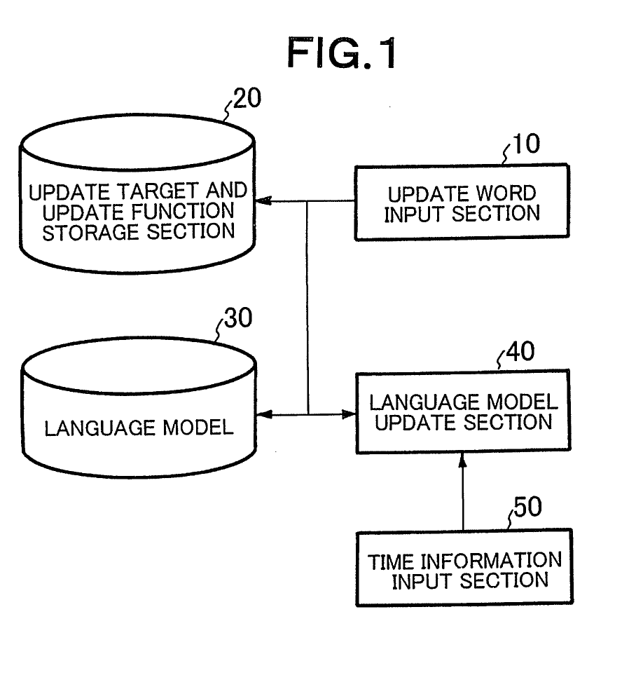

With reference to FIG. 1, a first exemplary embodiment of the present invention includes an update word input section (10 in FIG. 1), in which a word to be updated or a condition of words to be updated and an update function are input in a pair, an update target and update function storage section (20 in FIG. 1) that retains a word to be updated or a condition of words to be updated input in the update word input section 10 and an update function in a pair, a language model (30 in FIG. 1) that models a statistical appearance tendency of and restriction on a word to be recognized, a language model update section (40 in FIG. 1) that updates a language model of a word group that satisfies the word to be updated or the condition of words to be updated in accordance with the update function paired up with each of the update targets in accordance with passage of time, and a time information input section (50 in FIG. 1) that receives elapsed time from a time point set in advance or date and time information.

The update word input section 10 is a component that receives a word, for which a numerical value representing a statistical appearance tendency in a language model is to be changed according to passage of time, and an update function showing a change pattern thereof in a pair. With respect to the word, a format of directly designating a specific word may be used, or a word group may be designated in a format of designating a condition of words that the word group needs to satisfy. For example, a list that directly designates words, such as “air conditioner (noun)” and “electric fan (noun)” may be used, or a condition of words, such as “words that are adjective verbs and written with two or less characters”, may be designated. What description is accepted specifically as a condition of words varies depending on information provided to a recognition word that is retained in the language model 30. The condition may be any condition as long as a recognition word or a group of words retained in the language model 30 can be identified. In addition, some of words retained in the language model 30 may be classified into groups, such as “words related to winter sports”, and a name of the group may be designated as a condition of words to be updated.

The update function that is received in a pair with each of the words or the conditions of words to be updated may be in any format of a function, as long as a function using time as a parameter is used. In addition, although a language model of a word is normally configured with a plurality of numerical values representing a statistical appearance tendency of the word, separate update functions may be designated to the plurality of numerical values. Alternatively, only one update function is designated, and all of the plurality of numerical values representing a statistical appearance tendency of the word may have the designated update function as a coefficient to change in a linked manner. When a plurality of update functions are designated, which of the update functions is assigned to which part of the plurality of numerical values representing the statistical appearance tendency of the update target is all set in advance.

For example, in a voice recognition device, 3-gram showing a word sequence appearance probability of up to three words is often used as a language model. Assuming that a total number of words to be recognized is N, a language model of a certain word in 3-gram is shown by a vector constituted by (1+N+N×N) dimensions, as shown by (a single appearance probability of a word, a sequence appearance probability of two words, a sequence appearance probability of three words). Separate update functions may be designated to each of the elements, or only one update function is designated, and the update function may be used as a coefficient acting on all of the elements of the (1+N+N×N)-dimension vector.

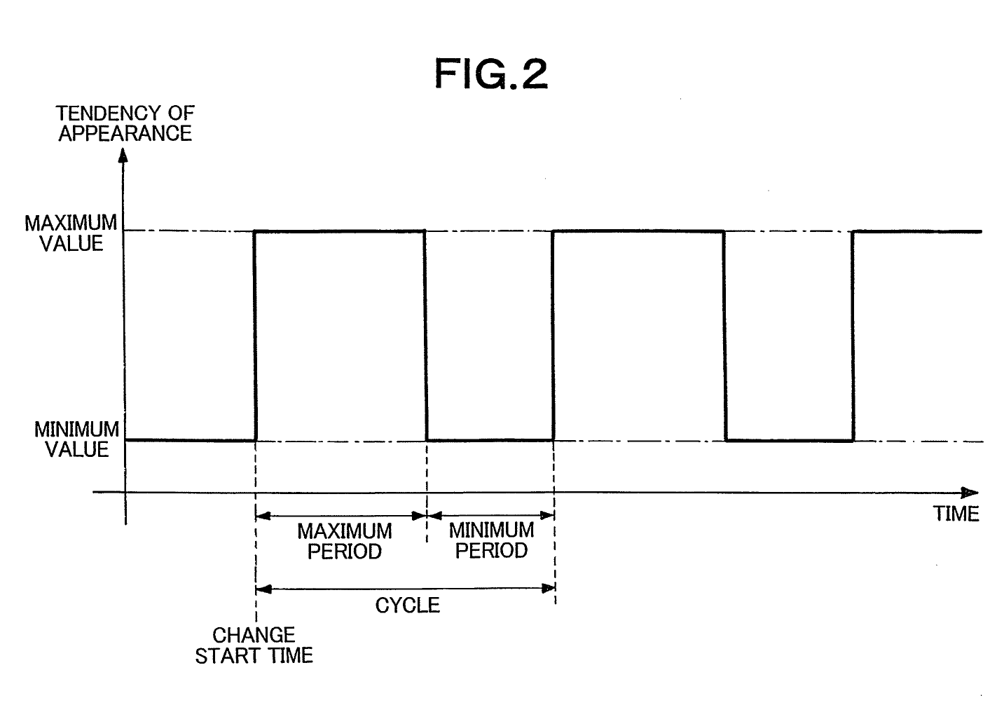

FIGS. 2 to 6 show change pattern examples set as update functions. In these examples, an entire appearance probability of a word as in a uni-gram appearance probability of a word is assumed to be changed in accordance with the change patterns, and detailed appearance probabilities in 2-gram and 3-gram are assumed to be ones obtained by multiplying a value at a certain point by the update functions as a coefficient. Also, the update function uses time as a parameter at all the time. In addition to time, the update function may have a plurality of parameters specifying a function form.

For example, FIG. 2 is an example of an update function, where a numerical value representing an appearance tendency of a word changes periodically in a pulse-like manner in accordance with passage of time. A function form like the one described above is considered to be used for words, such as “air conditioner” and “electric fan”, for which an appearance probability changes periodically in accordance with seasons, and words related to events that are generated at certain periods, such as Olympic-related words. In this function form, “Change Start Time” at which a first change starts, “Maximum Period” and “Minimum Period” that represent periods that the function continues to take a maximum vale and a minimum value, respectively, “Cycle” of change, and the like can be taken as parameters that specify the function form.

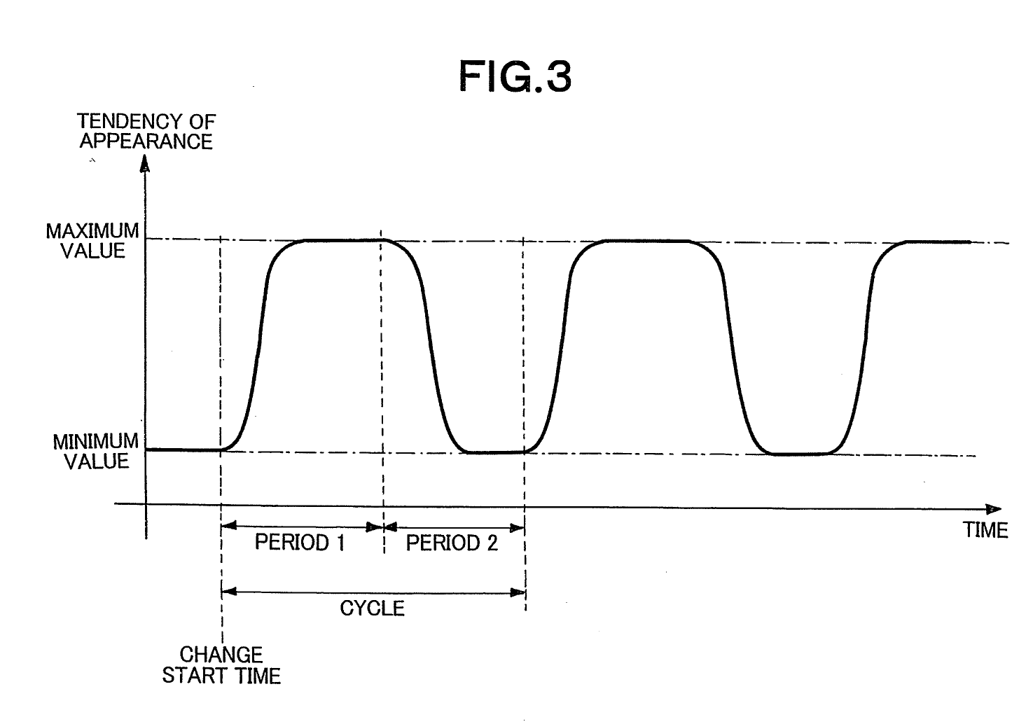

FIG. 3 is an example of an update function, where a numerical value that represents an appearance tendency of a word is increased or decreased periodically in accordance with passage of time, as similar to the example of FIG. 2. A difference from FIG. 2 is that the numerical value is not changed in a pulse-like manner, but is continuously increased or decreased within a certain period. Similarly, a function form like the one described above is considered to be used for words, such as “air conditioner” and “electric fan”, for which an appearance probability changes periodically in accordance with seasons, and words related to events that are generated at certain periods, such as Olympic-related words. In addition, in this function form, “Change Start Time” at which a first change starts, “Period 1” in which the function continues to increase, “Period 2” in which the function continues to decrease, “Cycle” of change, a gradient showing steepness of increase or decrease, and the like can be taken as parameters that specify the function form.

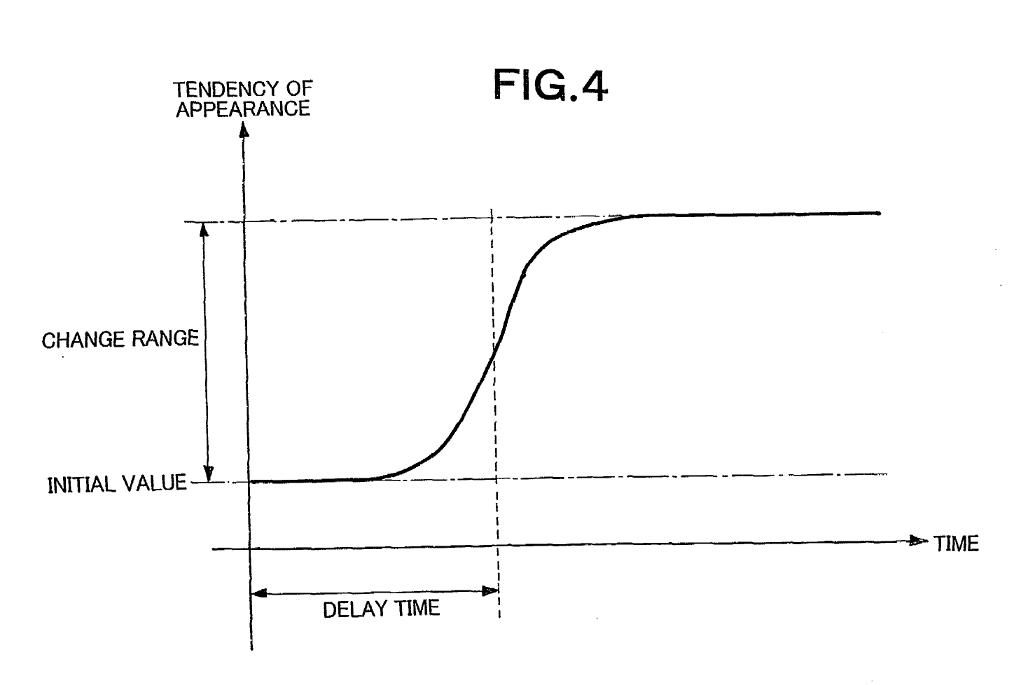

FIG. 4 is an example of an update function, where a numerical value that represents an appearance tendency of a word increases in accordance with passage of time, and then eventually converges to a certain value. For example, the above function form is considered to be used when a word that starts to be widely used recently, and is predicted to be continuously used at a certain value in future is added. As an example of the function form showing the above change pattern, there is a sigmoid function as specified in Formula (1) described below.

Tendency of Appearance=Initial Value+Change Range/(1+EXP(−Steepness of Change×(Time−Delay Time))) (1)

In the above formula, EXP( ) shows an exponential function. Parameters of this function includes “Initial Value”, “Change Range”, “Steepness of Change”, and “Delay Time”.

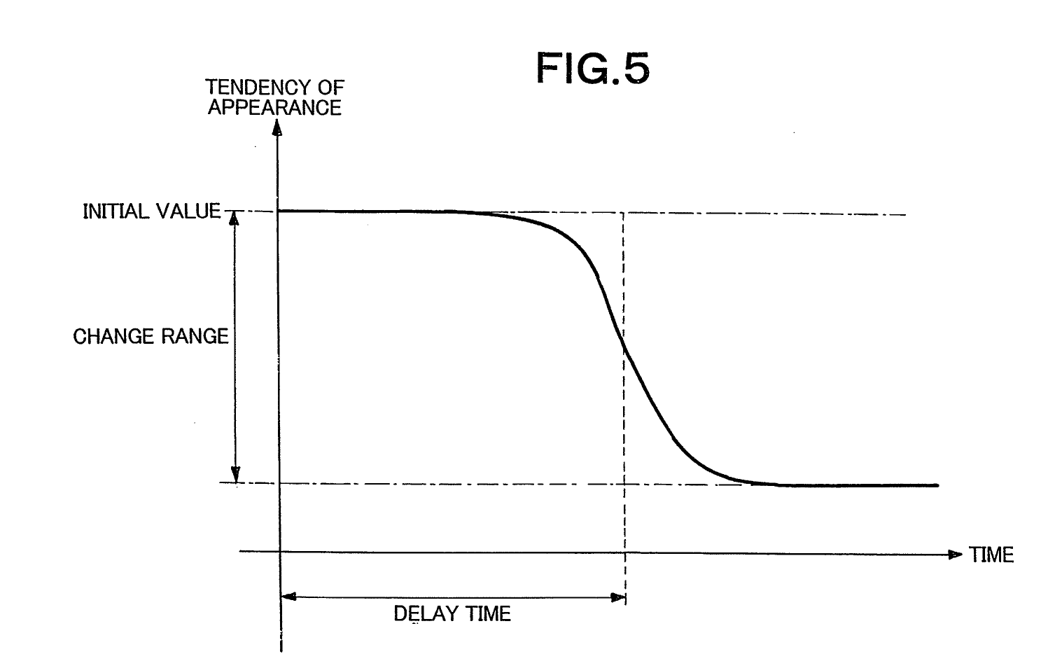

FIG. 5 is an example of an update function, where, as opposite to the example of FIG. 4, a numerical value that represents an appearance tendency of a word decreases in accordance with passage of time, and then eventually converges to a certain value. For example, the above function form is considered to be used when a word that is currently widely used, but is predicted to be out of date and used only in low proportion in future is added.

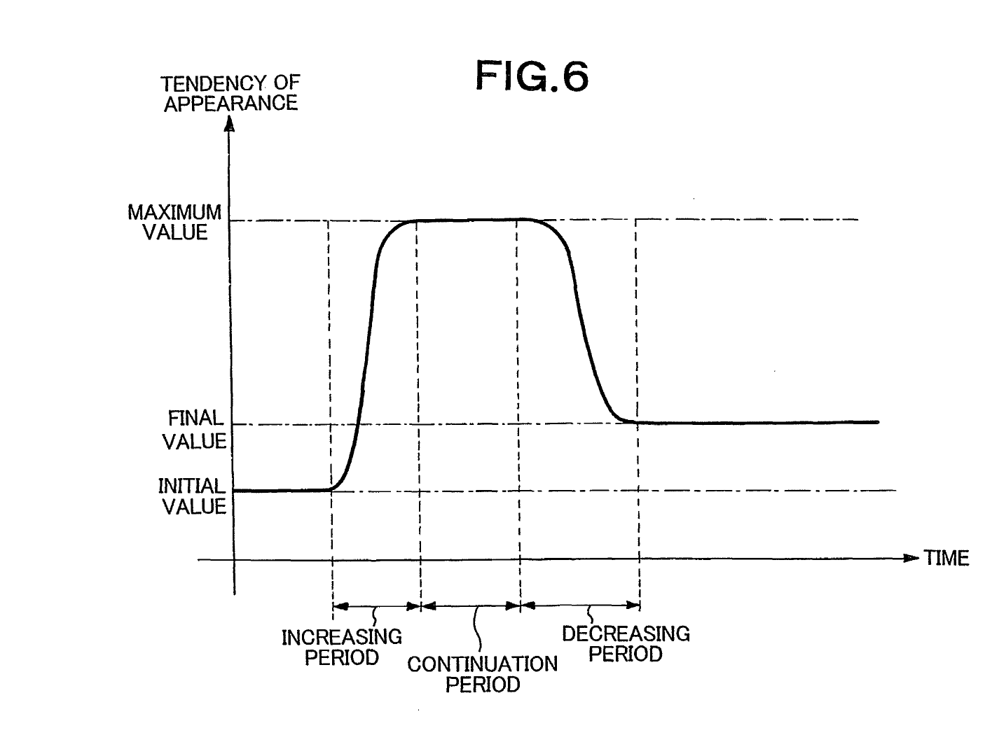

FIG. 6 shows an example of an update function, which is a combination of change patterns as shown in FIGS. 4 and 5, where a numerical value that represents an appearance tendency of a word increases to a certain value in accordance with passage of time, then eventually turns to decrease again, and finally converges to a certain value. For example, the function format as described above is considered to be used with respect to a word, such as a current word, that is predicted to be widely used for some time in future, but no longer used someday. In this function form, “Initial Value”, “Maximum Value”, “Final Value”, “Increasing Period”, “Continuation Period”, “Decreasing Period”, and the like can be taken as parameters that specify the function form.

The function forms shown in FIGS. 2 to 6 are examples of the update function, and change patterns that the update function may take are not limited to these function forms. Also, even in similar function forms, parameters that specify such function forms may be taken in various ways.

In addition, a method for specifically determining what word is to be updated by what update function is not a technical subject handled by the present invention. Such a method may be determined by the user using embodiments of the present invention based on his or her experience or a priori knowledge. Alternatively, a changing word and a changing pattern thereof may be calculated separately by a mechanical predicting means of some sort.

The embodiments of the present invention merely accept a pair of a word to be updated or a condition of words to be updated and an update function thereof that are input to the update word input section 10.

The update target and update function storage section 20 is a component that retains information of a pair of a word to be updated or a condition of words to be updated and an update function that are accepted by the update word input section 10. The update target and update function storage section 20 outputs the retained information when there is a request from the language model update section 40.

The language model 30 is a language model that models a statistical appearance tendency of and restriction on a word to be recognized. The language model itself is of an existing technique, and is not described in detail any further in the present description. A specific format of a language model to be taken is different depending on use and a purpose of when the embodiments of the present invention are employed.

The language model update section 40 is a component that receives time information from the time information input section 50 that will be described later, and updates a language model recorded in the language model 30 at an update timing set in advance with reference to the time information. When the time information received from the time information input section 50 is in a format of elapsed time, the update timing may be set to show an interval of update, such as every 24 hours or every 240 hours. When the time information received from the time information input section 50 is in a format of date and time, the setting may be that the first day in every month or may be 12 o'clock on Monday, Wednesday, and Friday every week, or the like. In addition, as the update timing, apart from a method of updating at every certain period of time, or on day, month, and year, on days of a week, or at time that are designated in advance, a trigger of an update timing may be received from the outside of the embodiment of the present invention, and then, at the time point that the trigger is received, the time information may be received from the time information input section 50, and then a language model recorded in the language model 30 may be updated. For example, the method may be such that, at the time when a recognition device that carries out voice recognition or character recognition executes recognition processing by using a language model updated in the embodiment of the present invention, a trigger of a language model update timing is output to the language model update section 40, the language model update section 40 updates a language model recorded in the language model 30, and then the recognition processing is carried out by using the updated language model.

At an update timing, the language model update section 40 reads in all of words to be updated or conditions for words to be updated and update functions retained in the update target and update function storage section 20. Then, the language model update section 40 updates a language model of a word to be updated or a group of words that satisfy a condition for update among recognized words in the language model 30 in accordance with each update function. At this time, each of the update functions is provided with time information at the time point of update as a parameter. When a word designated as the word to be updated does not exist in recognition words in the language model 30, the word is registered in the language model 30 as a new word. Then, a value of a language model of the newly registered word is obtained from a value of an update function at the time point.

When a language model recorded in the language model 30 includes a numerical value that represents an appearance probability of a word, such as an n-gram appearance probability, normalization may be carried out so that the numerical value in the language model satisfies a requirement as a probability value after update of the language model. Here, that “the numerical value in the language model satisfies a requirement as a probability value” means a condition that a value obtained by adding together probabilities of all cases that may occur becomes 1. When a language model of part of words is increased or decreased in accordance with an update function retained in the update target and update function storage section 20, an entire language model itself does not satisfy a requirement as a probability value as it is.

Therefore, the above normalization is required. However, when a language model recorded in the language model 30 is used by a recognition device not as a strict probability value, but as a numerical value that represents a mere appearance tendency of a word, the normalization is not required.

The time information input section 50 is a component that receives elapsed time from a time point set in advance or date and time information from a clock, and outputs the received time information to the language model update section 40. A format of the receiving time information may be date and time information, such as “12:00 on Jan. 1, 2006”, or may be elapsed time counted from a start point, such as “0:00 on Jan. 1, 2006”, that is set in advance. In addition, from which clock the time information is received is also set in advance. The clock may be incorporated in the time information input section 50 itself. Alternatively, the time information may be received from a remote clock that is connected through a network or electric wiring. From which clock the time information is specifically received, and the time information of what specific format is received are different depending on use and a purpose of when the embodiment of the present invention is employed.

So far, a configuration of the first exemplary embodiment of the present embodiment has been described.

In addition, in the present embodiment, components of the update word input section 10, the update target and update function storage section 20, the language model 30, the language model update section 40, and the time information input section 50 may be embodied as programs that control respective functions that are provided on a recording medium, such as a CD-ROM and a floppy disk, that can be mechanically read out, or through a network, such as the Internet, and read out and executed by a computer, and the like.

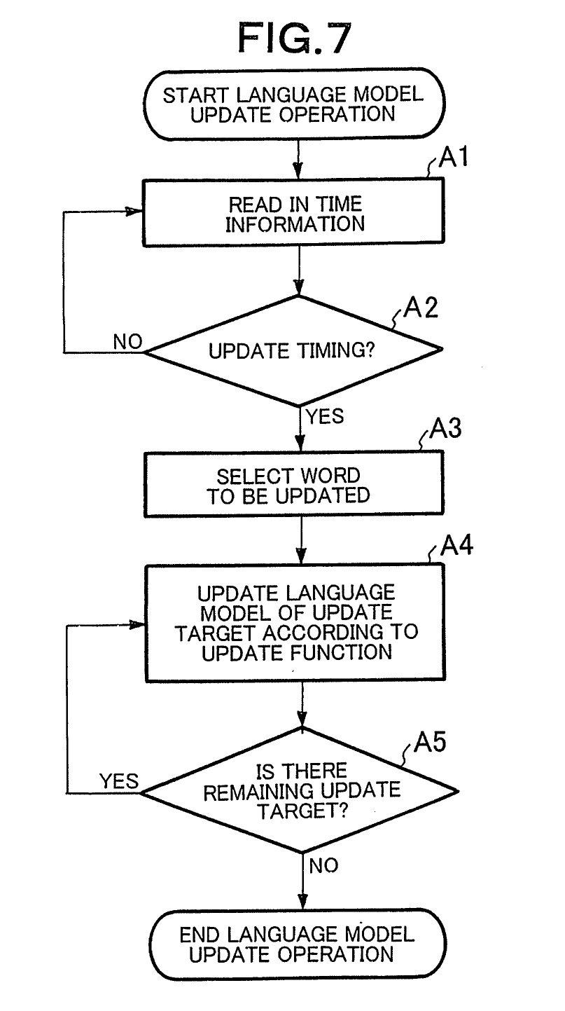

Next, description will be made with respect to operation of the language model update device according to the first exemplary embodiment of the present invention along a flowchart shown in FIG. 7.

In the operation of the language model update device according to the embodiment of the present invention, the language model update section 40 first reads in time information from the time information input section 50 (Step A1).

Then, based on the read-in time information, the language model update section 40 determines whether or not an update timing set in advance is reached (Step A2). When the update timing is not reached, the operation returns to Step A1.

When the update timing is reached, the language model update section 40 reads in information of a pair of an update target and an update function retained in the update target and update function storage section 20, and then selects a word or a group of words to be updated (Step A3).

After the language model update section 40 selects a word or a group of words to be updated, the language model update section 40 provides time information at that time point to an update function that is paired up with the word or the group of words as a parameter. In accordance with a result of the update function, the language model update section 40 updates a language model of the word or the group of words to be updated that is recorded in the language model 30. When there exist a plurality of update functions, the language model update section 40 provides time information to each of the update functions as a parameter, and uses results of the calculation to update a language model (Step A4).

When update of a language model of the selected word or group of words to be updated ends, the language model update section 40 determines whether or not there is any remaining word or group of words to be updated that is yet unprocessed (Step A5). When there is a remaining update target yet unprocessed, the operation returns to Step A3.

When update of a language model of all words or groups of words to be updated ends, the entire operation of the language model update device according to the first embodiment of the present invention ends.

Next, a second exemplary embodiment of the present invention will be described in detail with reference to the accompanying drawings and an example.

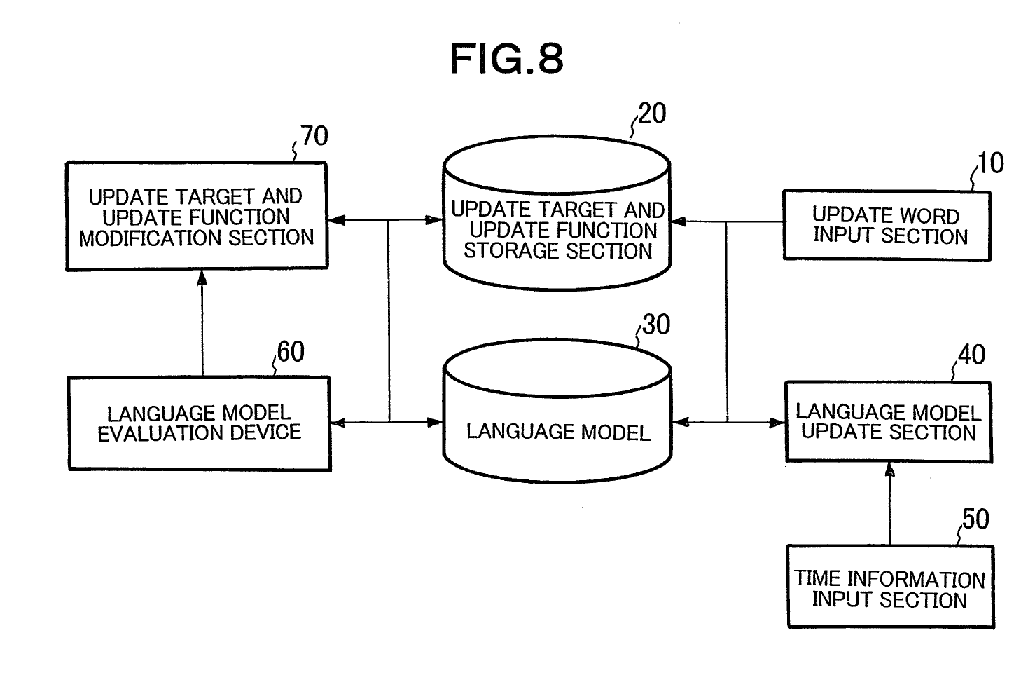

When FIG. 8 is referred to, the second exemplary embodiment of the present invention includes, in addition to the configuration of the first embodiment, a language model evaluation device (60 in FIG. 8) that evaluates a language model updated by the language model update section 40, and an update target and update function modification section (70 in FIG. 8) that modifies a word or a condition of words to be updated, an update function, or a language model in accordance with a result of evaluation of the language model evaluation device.

In the second exemplary embodiment of the present invention, each component of the update word input section 10, the update target and update function storage section 20, the language model 30, the language model update section 40, and the time information input section 50 works in a similar manner as that in the first embodiment. Accordingly, description will be made here only with respect to the language model evaluation device 60 and the update target and update function modification section 70 that are differences from the first embodiment.

The language model evaluation device 60 is a component that reads in a word to be updated or a condition of words to be updated from the update target and update function storage section 20, and evaluates a language model of each update target stored in the language model 30 for a type of each update function that is paired up with the update target. Here, the evaluation at least includes information, in which an appearance tendency of a word represented by a language model is specified to be any of (needs to be increased, a current appearance tendency is to be maintained, and needs to be decreased) with respect to a section of the language model that an individual update function of each update target acts on. More detailed evaluation information, for example, information that not only merely specifies that an appearance tendency of a word needs to be increased, but also specifies that the appearance tendency needs to be increased for how much, may be included.

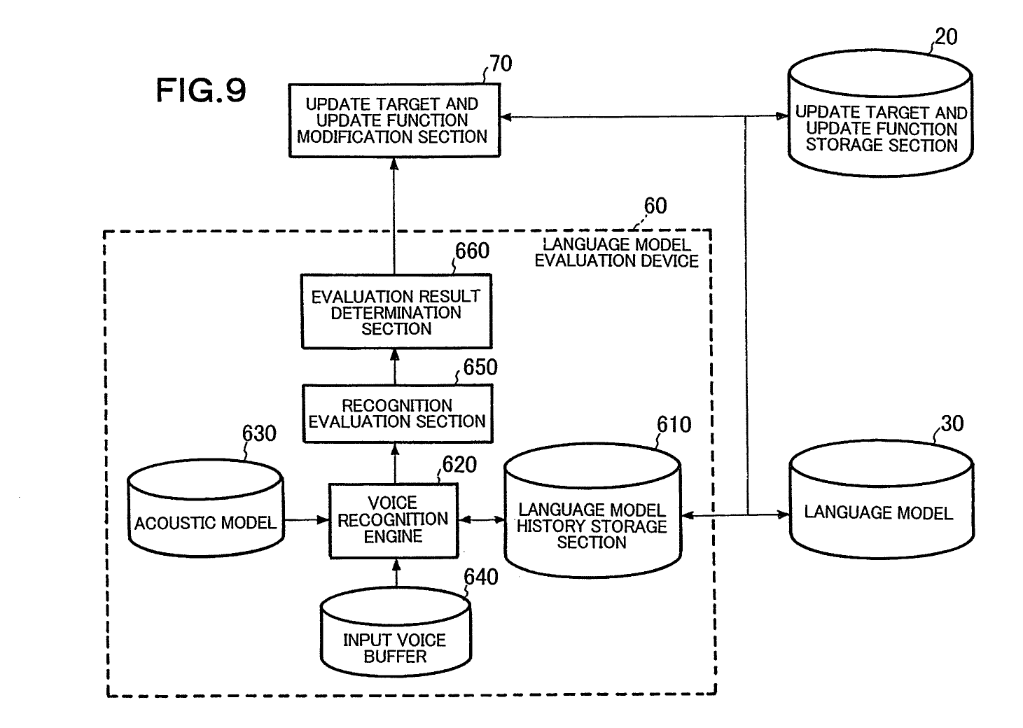

As a more detailed content of the language model evaluation device 60, for example, a configuration as shown in FIG. 9 can be considered.

When FIG. 9 is referred to, the language model evaluation device 60 includes a language model history storage section 610, a voice recognition engine 620, an acoustic model 630, an input voice buffer 640, a recognition evaluation section 650, and an evaluation result determination section 660.

The language model history storage section 610 is a component that stores an updated language model together with time information of an update timing every time a language model of the language model 30 is updated. The above storage is not carried out unlimitedly, but an updated language model is stored only for a certain number of times of update in the past. Also, when a language model is stored, instead of storing all the language model as it is, a method, such as storing only a difference from a language model that has already been stored, that is generally used for reducing required storage capacity may be used.

How many times of update of a language model in the past is stored is different depending on use or a purpose of employing the embodiment of the present invention. Also, instead of storing update of a latest language model for a certain number of times, a contrivance may be used to change a range of time of stored language models (a difference between an update timing of an oldest language model being stored and an update timing of a latest language model) to be a longer period while maintaining required storage capacity at a certain level, in such a manner as storing past updates every other time. A language model updated for a certain number of times in the past stored here is used for comparison and evaluation by the recognition evaluation section 650 described later.

Therefore, when a large number of update language models are stored, a large number of comparison targets are obtained and evaluation can be carried out more in detail. On the other hand, calculation time required for comparison becomes longer and storage capacity required for storing a language model updated in the past is increased. Accordingly, an appropriate number of times of storage may be determined by a tradeoff between obtained details of evaluation and calculation time and required storage capacity when the embodiment of the present invention is employed.

The voice recognition engine 620 is a voice recognition engine that is the same as a voice recognition engine that carries out recognition processing by using a language model to be updated by employing the embodiment of the present invention.

The voice recognition engines may be physically the same, or may be separate voice recognition engines having the same specification and performance.

The acoustic model 630 is an acoustic model used in the voice recognition engine 620. A content of the model is the same as one of an acoustic model used by a voice recognition engine that carries out recognition processing by using a language model to be updated by employing the embodiment of the present invention.

The acoustic models may be the same physically, or may be separate acoustic models having the same model content.

The input voice buffer 640 is a buffer that stores a certain amount of voice that is the same as voice input to a voice recognition engine that carries out recognition processing by using a language model that is updated by using the embodiment of the present invention, or voice having an appearance tendency of a word that is similar to an appearance tendency of a word included in voice input to a voice recognition engine that carries out recognition processing by using a language model that is updated by using the embodiment of the present invention. Voice stored in the input voice buffer 640 is used for evaluating a language model that is updated most recently at the recognition evaluation section 650 described later. Accordingly, the older the voice stored here is than a timing at which a language model is updated most recently, the more inappropriate the voice is for evaluating the language model that is updated most recently. On the other hand, the less an amount of the voice used for the evaluation is, the more inaccurate the evaluation at the recognition evaluation section 650 becomes. Therefore, an amount of voice stored in the input voice buffer 640 and that voice of how past is to be recorded are set in advance based on an amount of input voice provided to a voice recognition engine that carries out recognition processing by using a language model that is updated by employing the embodiment of the present invention.

The recognition evaluation section 650 is a component that inputs voice stored in the input voice buffer 640 in the voice recognition engine 620, and evaluates a language model stored in the language model history storage section 610. As a specific evaluation method, a method of actually recognizing input voice by using a voice recognition engine, and using a statistical likelihood of a result of the recognition is known as a publicly-known technique. Patent Document 2 is an example of the technique.

What evaluation method is actually used is not to be handled in the present invention, and not described in further detail here.

Evaluation of a language model is not carried out for each language model stored in the language model history storage section 610, but carried out for each type of an update function of each update target after subdividing each language model further. For example, when there are words A and B as targets of update, and A1, A2, B1, and B2 as update functions of these words, each of the update functions of each language model is evaluated individually, in such a manner that evaluation of a language model that is updated most recently is highest with respect to A1, whereas evaluation of a language model updated previously is highest with respect to B2, and the like. However, when voice stored in the input voice buffer 640 is insufficient for evaluating a certain update function, evaluation is not carried out with respect to the update function. For example, when a recognition result of voice stored in the input voice buffer 640 does not include a word A, evaluation is not carried out for an update function having A as an update target. Evaluation of each update function of each language model is output to the evaluation result determination section 660.

The evaluation result determination section 660 selects a language model at a point in time, for which evaluation is maximum among past language models stored in the language model history storage section 610, for each update function of each update target. Then, a difference with respect to a focused update function between the language model, for which evaluation with respect to each update function of each update function is maximum, and a language model that is most recently updated is obtained. As a result, the difference obtained for each update function of each update target shows a direction and degree of modification for modification applied to a language model that is most recently updated.

So far, an example of the configuration showing a detailed content of the language model evaluation device 60 has been described.

In FIG. 9, a language model updated in the embodiment of the present invention is assumed to be used in a voice recognition device, and the internal configuration of the language model evaluation device 60 includes the voice recognition engine 620, the acoustic model 630, and the input voice buffer 640. However, even when a language model updated in the embodiment of the present invention is used in a character recognition device, the language model evaluation device 60 can be configured with completely the same configuration. In such a case, the voice recognition engine 620 may be replaced with a character recognition engine, the acoustic model 630 is replaced with a character standard pattern, and the input voice buffer 640 is replaced with an input image buffer.

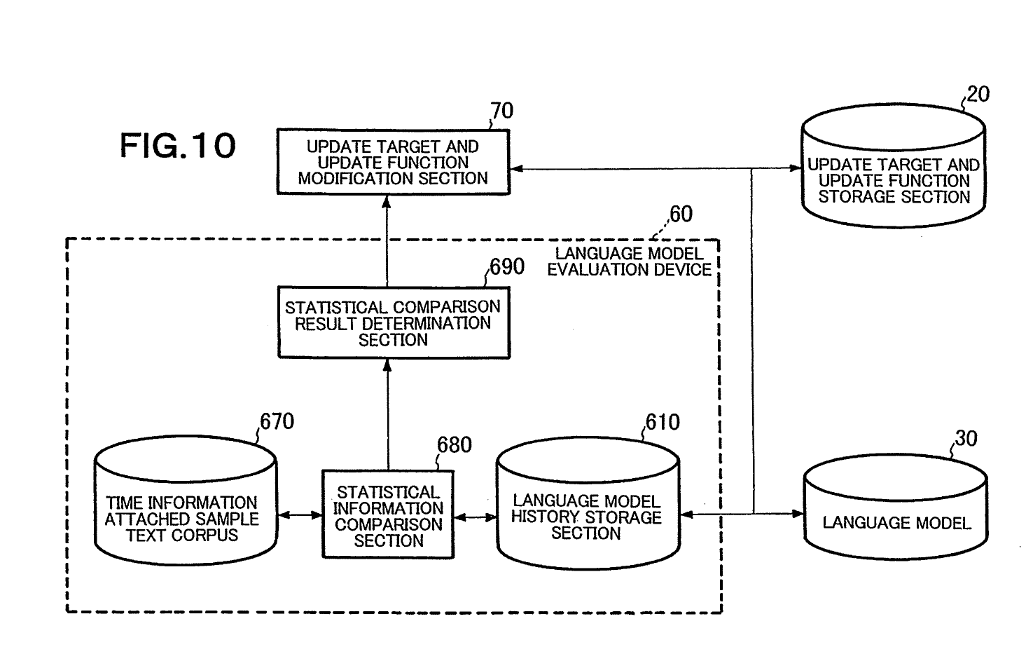

As another detailed content of the language model evaluation device 60, for example, a configuration as shown in FIG. 10 can be considered.

When FIG. 10 is referred to, the language model evaluation device 60 includes the language model history storage section 610, a time information attached sample text corpus 670, a statistical information comparison section 680, and a statistical comparison result determination section 690.

The language model history storage section 610 is completely the same as the language model history storage section 610 in FIG. 9.

The time information attached sample text corpus 670 is a corpus of text, where each text is provided with time information, at which the text is created. Here, the time information employs the same format as the time information accepted by the time information input section 50, or a format that can be converted to the format of the time information accepted by the time information input section 50. Not all text that is provided with the time information is accepted. The text needs to be text of the same type created under a certain environment.

For example, a corpus in which conditions of an amount, a style, and the like at each time point do not change in accordance with passage of time, such as a newspaper corpus is considered. Corpuses that satisfy the above condition other than a newspaper corpus include a mail magazine created periodically by the same author, publicity, a catalogue, an instruction manual, and the like. A method in which a corpus is statistically regarded as text created under a certain environment when an amount of the corpus is increased despite the fact that the corpus is not created by the same author may as well be employed. As an example of this corpus, a method of collecting a large amount of blogs that are open to the public on the Internet, and setting such blogs as a sample text corpus attached with time information can be considered.

Further, text stored in the time information attached sample text corpus 670 at this time desirably includes words that are designated as update targets at the update word input section 10 as many as possible. However, this is not an absolute condition.

The statistical information comparison section 680 first reads in an update timing of each language model stored in the language model history storage section 610. Then, the statistical information comparison section 680 reads out text created in the same period as the each update timing from the time information attached sample text corpus 670, and calculates a statistical appearance tendency of each word to be updated based on the readout text. Further, the statistical information comparison section 680 compares the calculated statistical appearance tendency of the word to be updated at a time point of each of the update timing with a statistical appearance tendency of the word to be updated in a language model stored in the language model history storage section 610. Based on the premise that there is a proportionality between the calculated statistical appearance tendency of the word to be updated and the statistical appearance tendency of the word to be updated in the language model stored in the language model history storage section 610, the statistical information comparison section 680 calculates a prediction value of a language model at an update timing of most recent update based on a language model other than a language model that is most recently updated and the calculated statistical appearance tendency of the word to be updated. Then, the statistical information comparison section 680 outputs a difference between the obtained prediction value and an actual value of the language model that is most recently updated to the statistical comparison result determination section 690. For example, a specific newspaper corpus is assumed to be stored in the time information attached sample text corpus 670. Also, an appearance probability of a certain current word in each week is assumed to be (an appearance probability in the newspaper corpus, an appearance probability in a language model in each update timing)=(on June 1: 0.0020, 0.0060), (on June 8: 0.0018, 0.0054). Further, assuming that an appearance probability of the current word in the newspaper corpus at the time point of June 15 is 0.0010, a predicted appearance probability in a language model is obtained by Formula (2) below.

(((0.0060/0.0020)+(0.0054/0.0018))/2)×0.0010=0.0030 (2)

In this formula, an appearance probability of the current word in the language model on June 15 is predicted based on an average of ratios between the appearance probabilities in the newspaper corpus and the appearance probabilities in the language model in past two weeks and the appearance probability in the newspaper corpus on June 15. On the other hand, an appearance probability of the current word in the language model on June 15 that is stored in the language model history storage section 610 is assumed to be 0.0050.

This indicates that the current word becomes out of date more rapidly than the appearance probability predicted based on the update function of the current word. This difference is output to the statistical comparison result determination section 690.

When a word to be updated is not used in text retained in the time information attached sample text corpus 670 for a long period of time, the word to be updated is not evaluated. A threshold value for the long period is set in advance in accordance with an environment of employing the embodiment of the present invention and a characteristic of a sample text corpus attached with time information being used. However, even when a word to be updated itself does not appear in text retained in the time information attached sample text corpus 670, the present invention may employ a method of comparing an appearance tendency with that of a word that is predicted in advance to show a similar appearance tendency, so as to obtain a difference between a predicted appearance tendency and an appearance tendency in a language model that is most recently updated. For example, there is assumed to be a group of words input to the update word input section 10 as sport meeting related words as a group. Even if not all of the words in the group do not appear in text retained in the time information attached sample text corpus 670, a difference between appearance tendencies of the words can be obtained by comparing an average value of appearance tendencies of part of the words that appear in the text with an appearance tendency of each word of the group to be updated.

At this time, when conditions of a style and the like are different between the text retained in the time information attached sample text corpus 670 and a text corpus used when the language model 30 is created, the text retained in the time information attached sample text corpus 670 cannot be used for the purpose of directly creating a language model. However, the text retained in the time information attached sample text corpus 670 can be used for comparison with an appearance tendency of a word to be updated. This point is an advantage of the configuration of the language model evaluation device 60.

The statistical comparison result determination section 690 outputs a direction along which each update function for each update target in a language model that is most recently updated is modified, and a degree of such modification based on a difference between appearance tendencies of words to be updated to the update target and update function modification section 70. However, with respect to a word to be updated, for which a difference of an appearance tendency is not obtained, and when only part of differences between appearance tendencies are obtained and direction and degree for modification of update functions cannot be determined, determination is not carried out with respect to all of the words to be updated and the part of update functions.

For example, in the example of the current word described with respect to the statistical information comparison section 680, an appearance tendency of the current word in a language model that is most recently updated is 0.0050, whereas a prediction obtained from the time information attached sample text corpus 670 is 0.0030. Therefore, when there is an update function for obtaining an appearance probability of the current word alone, the statistical comparison result determination section 690 outputs that a function form of the update function needs to be modified so that a value of the update function at the update timing is reduced only for 0.0020.

So far, an example of the configuration showing a detailed content of the language model evaluation device 60 has been described. Although the two configuration examples as shown in FIGS. 9 and 10 have been shown, the configuration of the language model evaluation device 60 is not limited to these configurations. The language model evaluation device 60 may take any configuration, as long as that the language model evaluation device 60 is a component that reads in a word to be updated or a condition of words to be updated from the update target and update function storage section 20, and evaluates a language model of each update target stored in the language model 30 for a type of each update function that is paired up with the update target. As methods for evaluating a language model, there are a variety of techniques that are open to public, such as Patent Document 2, and such a method is not a subject matter of the present invention. Accordingly, description of such a method will not be made here any further.

The update target and update function modification section 70 reads in an output of the language model evaluation device 60, and modifies an update function retained in the update target and update function storage section 20, so that evaluation is reflected for each update function for which the evaluation is obtained and evaluation of a language model that is most recently updated becomes better. As a modification method of an update function, there are a method of adjusting a parameter set for each update function, and a method of changing an entire function of an update function. When a parameter is adjusted, the parameter is changed in a manner that evaluation of a language model becomes better by employing a steepest descent method, and the like. Alternatively, which parameter is changed in what priority and to what extent in a plurality of parameters may be set for each update function in advance. In addition, when an entire update function is changed, a function form after the change that shows what update function the update function needs to be changed to need be set in advance. For example, when an update function is defined in the sigmoid function as shown in Formula (1), and a value larger than the value of the update function needs to be obtained, the parameter of “Change Range” in Formula (1) is increased.

In addition, in the update target and update function modification section 70, a value retained in the language model 30 may be directly modified, instead of modifying update function retained in the update target and update function storage section 20, so that evaluation of a language model that is updated most recently become better. Whether modification of an update function of the update target and update function storage section 20 is carried out, modification of a value of the language model 30 is carried out, or both of the modifications are carried out, is set in advance in accordance with use and a purpose of employing the embodiment of the present invention.

Further, when all of update functions that are paired up with words or conditions of words to be updated are functions that take a certain value that does not change with respect to time, the words or the conditions of words to be updated themselves may be removed from the update target and update function storage section 20.

So far, a configuration of the second exemplary embodiment of the present invention has been described.

In addition, in the present embodiment, components of the update word input section 10, the update target and update function storage section 20, the language model 30, the language model update section 40, the time information input section 50, the language model evaluation device 60, and the update target and update function modification section 70 may be embodied as programs that control respective functions, provided on a recording medium such as a CD-ROM and a floppy disk that can be mechanically read out, or through a network such as the Internet, and read out and executed by a computer, and the like.

Next, description will be made with respect to operation of the language model update device according to the second exemplary embodiment of the present invention. The operation of the language model update device according to the second embodiment of the present invention includes language model update operation and update target and update function modification operation that operate independently from each other.

The language model update operation in the second exemplary embodiment of the present invention is completely the same as the language model update operation in the first embodiment, and therefore description of the language model update operation is omitted here.

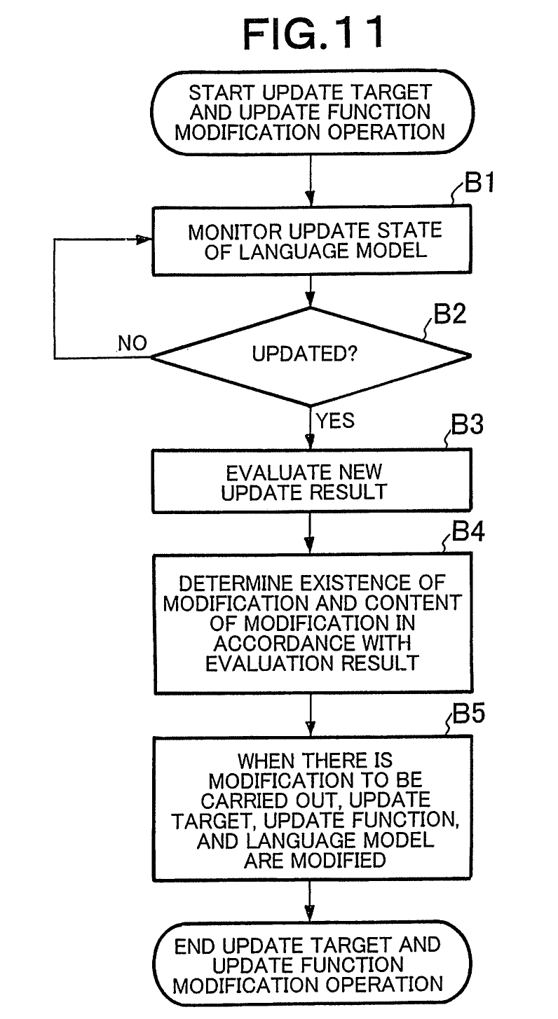

The update target and update function modification operation in the second exemplary embodiment of the present invention will be described along the flowchart of FIG. 11.

In the update target and update function modification operation according to the embodiment of the present invention, the language model 30 is first checked, so that whether or not a language model has been updated is monitored (Step B1).

When a language model is not updated, the monitoring is continued. When a language model is updated, the operation moves to evaluation with respect to the language model that is most recently updated (Step B2).

The language model evaluation device 60 evaluates the language model that is most recently updated (Step B3). In accordance with a result of the evaluation, the update target and update function modification section 70 determines each update function, a language model retained in the language model 30, and also existence of modification of a word or a condition of words to be updated and a content of the modification (Step B4). If there is modification to be carried out, the modification is carried out (Step B5).

By performing the above operation, and also by combining the operation with the language model update operation that operates independently, the entire operation in the language model update device according to the second embodiment of the present invention ends.

A second exemplary object of the present invention is to further provide a language model update device, a language model update method, and a language model update program that include a means for evaluating an updated language model, determine whether or not an update function set for each word is appropriate by evaluating a language model that has changed according to passage of time, and adjust a parameter that specifies a function form of the update function when the update function is not appropriate.

According to a second exemplary aspect of the present invention, there is provided a language model update method, characterized by including a time information inputting step for receiving elapsed time from a time point set in advance or date and time information, an update target and update function storing step for retaining a pair of a word to be updated or a condition of words to be updated and an update function, and a language model updating step for updating a language model of the word to be updated or a group of words that satisfy the condition of words to be updated based on the update function that is paired up with each of the update targets in accordance with the elapsed time received by the time information inputting step.

According to a third exemplary aspect of the present invention, there is provided a language model update program that updates a language model by controlling a computer, characterized by controlling the computer to execute a time information inputting step for receiving elapsed time from a time point set in advance or date and time information, an update target and update function storing step for retaining a pair of a word to be updated or a condition of words to be updated and an update function, and a language model updating step for updating a language model of the word to be updated or a group of words that satisfy the condition of words to be updated based on the update function that is paired up with each of the update targets in accordance with the elapsed time received in the time information inputting step.

With respect to the exemplary embodiments of the present invention described in detail, various changes, substitutions, and alternatives are understood to be made without deviating from a sprit and a scope of the invention defined by claims. In addition, even if amendment is made during proceedings of the application, the inventor intends that the equivalent of the claimed invention is maintained.

### INDUSTRIAL APPLICABILITY

The present invention can be applied to a voice recognition device that requires a new word, a current word, and the like to be added to a recognition dictionary for the purpose of maintaining a state of a language model used by the voice recognition device to be appropriate. In particular, the present invention is effectively applied to a voice recognition device that is incorporated in a household appliance, for which the user cannot easily manage and update a language model expressly after words are registered.

In addition, as similar to the case of the voice recognition device, the present invention can be applied to a character recognition device that requires a new word, a current word, and the like to be added to a recognition dictionary for the purpose of maintaining a state of a language model used by the character recognition device to be appropriate. In particular, the present invention is effectively applied to a character recognition device that is incorporated in a household appliance for which the user cannot easily manage and update a language model expressly after words are registered.

1. A language model update device, comprising:
time information inputting means for receiving elapsed time from a time point set in advance or date and time information;
update target and update function storing means for retaining a pair of a word to be updated or a condition of words to be updated and an update function; and
language model updating means for updating a language model of the word to be updated or a group of words that satisfy the condition of words to be updated based on the update function that is paired up with each of the update targets in accordance with the elapsed time received by the time information inputting means.

2. The language model update device according to claim 1, further comprising:
language model evaluating means for evaluating the language model updated by the language model updating means; and
update target and update function modifying means for modifying the word or the condition of words to be updated, the update function, or the language model in accordance with a result of the evaluation by the language model evaluating means.

3. A voice recognition processing device that carries out voice recognition by using the language model updated in the language model update device according to claim 1.

4. A character recognition processing device that carries out character recognition by using the language model updated in the language model update device according to claim 1.

5. A language model update method, comprising:
a time information inputting step for receiving elapsed time from a time point set in advance or date and time information;
an update target and update function storing step for retaining a pair of a word to be updated or a condition of words to be updated and an update function; and
a language model updating step for updating a language model of the word to be updated or a group of words that satisfy the condition of words to be updated based on the update function that is paired up with each of the update targets in accordance with the elapsed time received in the time information inputting step.

6. The language model update method according to claim 5, further comprising:
a language model evaluating step for evaluating the language model updated by the language model updating step; and
an update target and update function modifying step for modifying the word or the condition of words to be updated, the update function, or the language model in accordance with a result of the evaluation by the language model evaluating step.

7. A voice recognition processing method that carries out voice recognition by using the language model updated in the language model update method according to claim 5.

8. A character recognition processing method that carries out character recognition by using the language model updated in the language model update method according to claim 5.

9. A language model update program that updates a language model by controlling a computer, the program, when executed by the computer, controlling the computer to execute:
a time information inputting step for receiving elapsed time from a time point set in advance or date and time information;
an update target and update function storing step for retaining a pair of a word to be updated or a condition of words to be updated and an update function; and
a language model updating step for updating a language model of the word to be updated or a group of words that satisfy the condition of words to be updated based on the update function that is paired up with each of the update targets in accordance with the elapsed time received in the time information inputting step.

10. The language model update program according to claim 9, the program, when executed by the computer, controlling the computer to further execute:
a language model evaluating step for evaluating the language model updated by the language model updating step; and
an update target and update function modifying step for modifying the word or the condition of words to be updated, the update function, or the language model in accordance with a result of the evaluation by the language model evaluating step.

11. A voice recognition processing program that controls the computer to execute a voice recognition step for carrying out voice recognition using the language model updated in the language model update program according to claim 9.

12. A character recognition processing program that controls the computer to execute a character recognition step for carrying out character recognition using the language model updated in the language model update program according to claim 9.

13. A voice recognition processing device that carries out voice recognition by using the language model updated in the language model update device according to claim 2.

14. A character recognition processing device that carries out character recognition by using the language model updated in the language model update device according to claim 2.

15. A voice recognition processing method that carries out voice recognition by using the language model updated in the language model update method according to claim 6.

16. A character recognition processing method that carries out character recognition by using the language model updated in the language model update method according to claim 6.

17. A voice recognition processing program that controls the computer to execute a voice recognition step for carrying out voice recognition using the language model updated in the language model update program according to claim 10.

18. A character recognition processing program that controls the computer to execute a character recognition step for carrying out character recognition using the language model updated in the language model update program according to claim 10.
